(19) United States
(12) Patent Application Publication
(10) Pub. No.: US 2005/0029071 A1
(43) Pub. Date: Feb. 10, 2005

(54) Noise-free sprocket wheel

(76) Inventor: Yi-Hsung Hsu, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/635,553

(22) Filed: Aug. 7, 2003

(51) Int. Cl. F16D 41/28

(52) U.S. Cl. 192/64; 192/45.1; 192/110 B

(57) ABSTRACT

A bicycle sprocket wheel has a sprocket wheel body provided with teeth formed on an outer periphery thereof to adapt to a bicycle chain so as to be driven to rotate by the bicycle chain, a driving ring received in the sprocket wheel body, a sleeve adapted to engage with a rear wheel of the bicycle so as to rotate simultaneously with the rear wheel and being inserted into the driving ring to engage with a side pad. The driving ring is so configured that the driving ring is selectively rotated with the sprocket wheel body and thus is noise-free.

### BACKGROUND OF THE INVENTION

1. Field of the Invention

The present invention relates to a sprocket wheel, and more particularly to a noise-free sprocket wheel. The sprocket wheel has a driving ring with multiple through holes defined to respectively receive therein a driving block and an elastic belt mounted on the driving blocks. Each block is so configured that when the sleeve in the sprocket wheel is rotating and the sprocket wheel body is not rotating, the driving blocks are tilted so that there is no connection between the sleeve and the sprocket wheel body. Thus, the sprocket wheel is noise-free in comparison with prior art sprocket wheels.

2. Description of Related Art

With reference to FIGS. 6 and 7, when a pedal (50) is turned, a rear wheel (53) is driven to rotate via a conventional sprocket wheel (51) and a chain (52). The conventional sprocket wheel (51) is composed of a sleeve (70) connected to the axle (not shown) of the rear wheel (53) and a sprocket wheel body (60).

The sleeve (70) has at least two recesses (72) defined in an outer periphery thereof and each recess (72) receives therein a clamp (71) and a spring (73) connected to a distal end of the clamp (71). The sprocket wheel body (60) has a first tooth (61) formed on an inner periphery thereof and a second tooth (62) formed on an outer periphery thereof. With such an arrangement, the clamps (71) are able to be detachably connected to the first teeth (61). The chain (52) is mounted on the second teeth (62). When the user turns the pedals (50), the chain (52) will drive the sprocket wheel body (60) to rotate in a clockwise direction (as shown from the drawing). In the meantime, the first teeth (61) on the inner periphery of the sprocket wheel body (60) engage with the clamp (71) such that the sleeve (70) rotates simultaneously with the axle of the rear wheel (53).

When the user is not turning the pedals (50) yet the bicycle is still moving forward, such as when going downhill, the sprocket wheel body (60) remains still. However, the sleeve (70) still moves along the rear wheel (53) so that the clamp (71) moves over the first teeth (61) and thus noise is generated. Besides, the angular distance θ between two pitches of two first teeth (61) causes a gap in power transmission. That is, the power transmission from the chain (52) is not able to be transmitted to the sprocket wheel body (60) at the moment when the user turns the pedals (50). Although there are at least two clamps (71), the force from the chain (52) to the sprocket wheel body (60) normally is applied to a single clamp (71). When the force is too large or too sudden, the clamp might easily be broken.

To overcome the shortcomings, the present invention intends to provide an improved sprocket wheel to mitigate or obviate the aforementioned problems.

### SUMMARY OF THE INVENTION

The primary objective of the invention is to provide an improved sprocket wheel having multiple driving blocks movably received in the sprocket wheel body so that when the driving blocks are tilted, the rotation of the sleeve is not able to drive the sprocket wheel body to rotate simultaneously. That is, if the sprocket wheel body is still and the sleeve is still rotating, the driving blocks will be tilted so that there is no connection between the sleeve and the sprocket wheel body and thus noise is eliminated.

Another objective of the present invention is to provide an elastic belt mounted on each of the driving blocks so as to secure the positions of the driving blocks in the driving ring.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the sprocket wheel of the present invention;

FIG. 2 is an exploded view of the sleeve and the assembled sprocket wheel body, the driving ring and the side cap;

FIG. 3 is a cross sectional showing the inner structure of the sprocket wheel of the present invention;

FIG. 4 is an enlarged side view showing the application of the sprocket wheel, wherein the sprocket wheel body is rotating simultaneously with the sleeve;

FIG. 5 is an enlarged side view showing the application of the sprocket wheel, wherein the sprocket wheel body remains still while the sleeve is rotating;

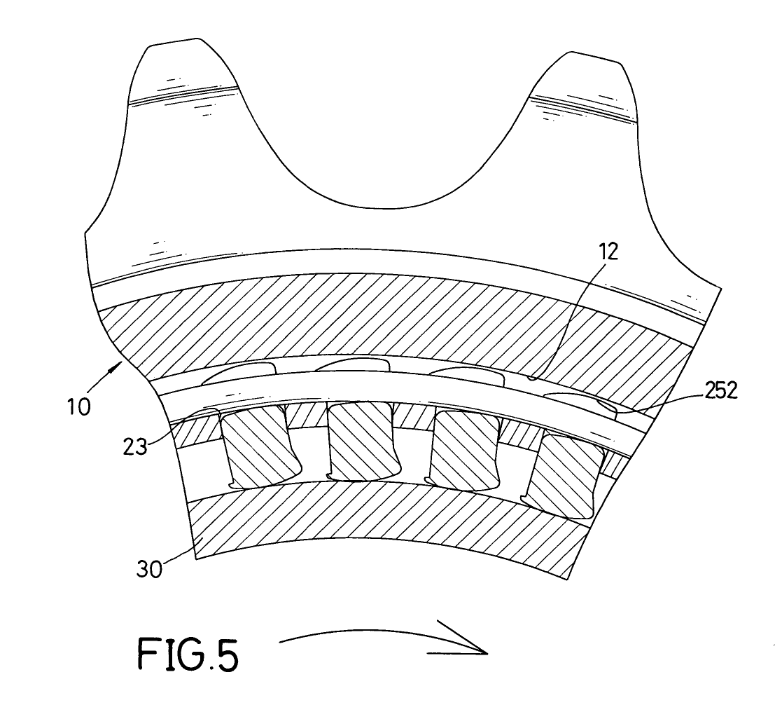

FIG. 6 is a perspective view of a bicycle with a conventional sprocket wheel; and

FIG. 7 is a schematic side view showing the application of the conventional sprocket wheel.

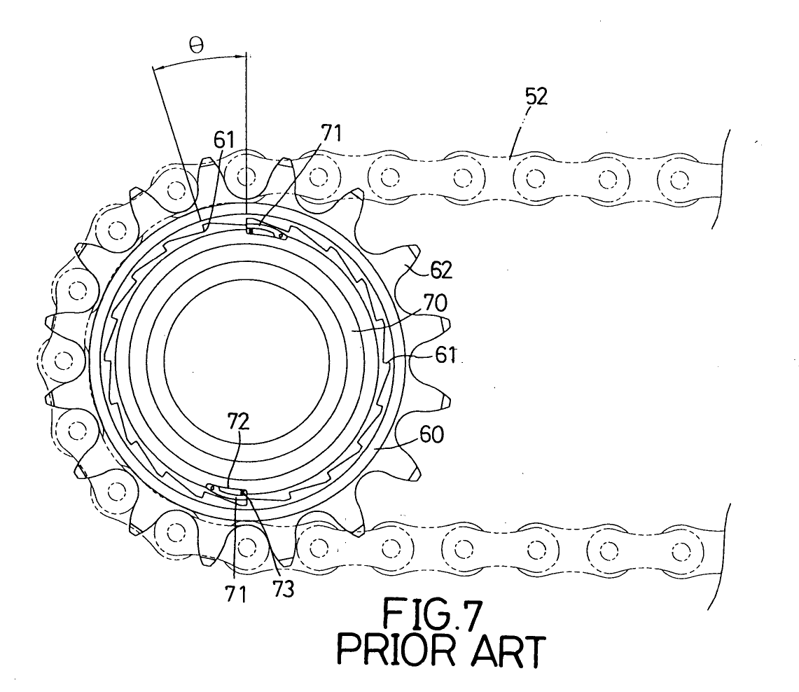

### DETAILED DESCRIPTION OF PREFERRED EMBODIMENT

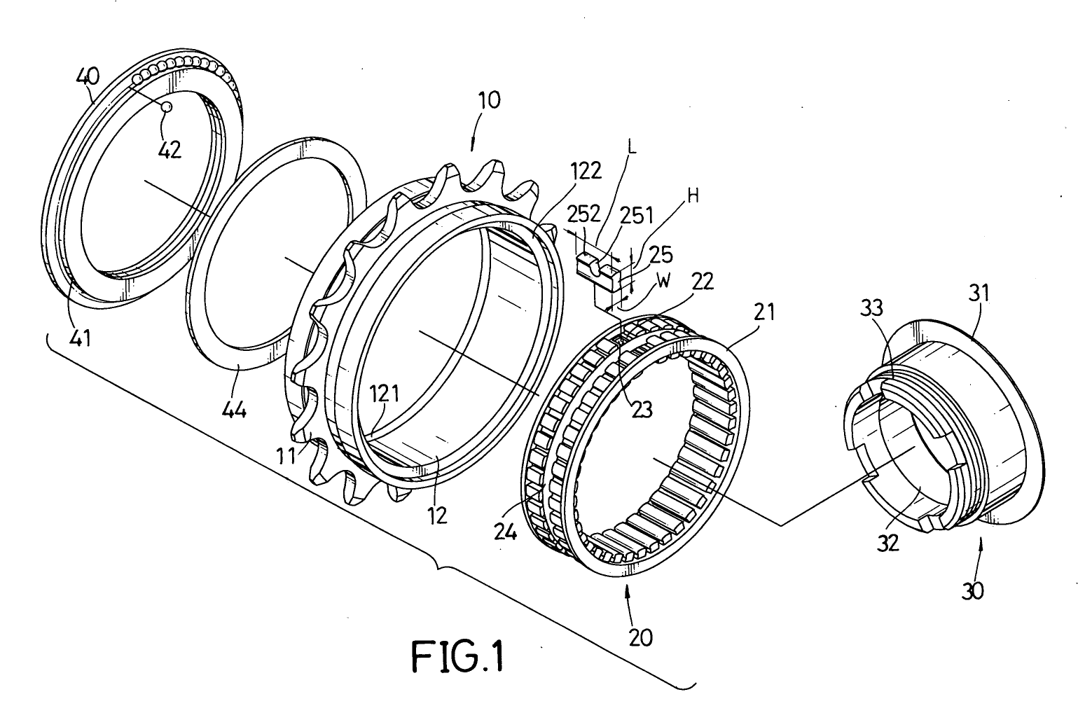

With reference to FIG. 1, the sprocket wheel of the present invention has a sprocket wheel body (10), a driving ring (20), a sleeve (30) and a side cap (40).

The sprocket wheel body (10) is hollow and has teeth (11) formed on an outer periphery of the sprocket wheel body (10) to adapt to a chain of the bicycle (not shown), a space (12) defined in the center of the sprocket wheel body (10), a first annular recess (121) and a second annular recess (122). Both the first and second annular recesses (121,122) are formed on a peripheral edge of the sprocket wheel body (10) and opposite to each other.

The driving ring (20) is able to be received in the space (12) of the sprocket wheel body (10) and has an outer skirt (21) with multiple partitions (22) formed in the outer skirt (21) so as to define multiple through holes (23) in the driving ring (20) for receiving therein multiple driving blocks (25). Each driving block (25) is configured to have a length L slightly larger than a length of the through hole (23) and a width W slightly smaller than a width of the through hole (23). The driving block (25) has a cutout (251) defined in a mediate portion thereof and an arcuate top face (252). After each driving block (25) is received in a corresponding one of the through holes (23) and the cutouts (251) are aligned with one another, an elastic belt (24) is provided to be received in the aligned cutouts (251) so as to secure the driving blocks (25) in position.

The sleeve (30) has a flange (31) formed on one peripheral edge thereof to correspond to the second annular recess (122), an inner threading (32) and an outer threading (33).

The side cap (40) has a ball receiving recess (41) defined to correspond to the first annular recess (121) of the sprocket wheel body (10) for receiving therein multiple balls (42) and an inner threading (43) formed to correspond to the outer threading (33) of the sleeve (30). An annular pad (44) is provided to correspond to one side of the driving ring (20).

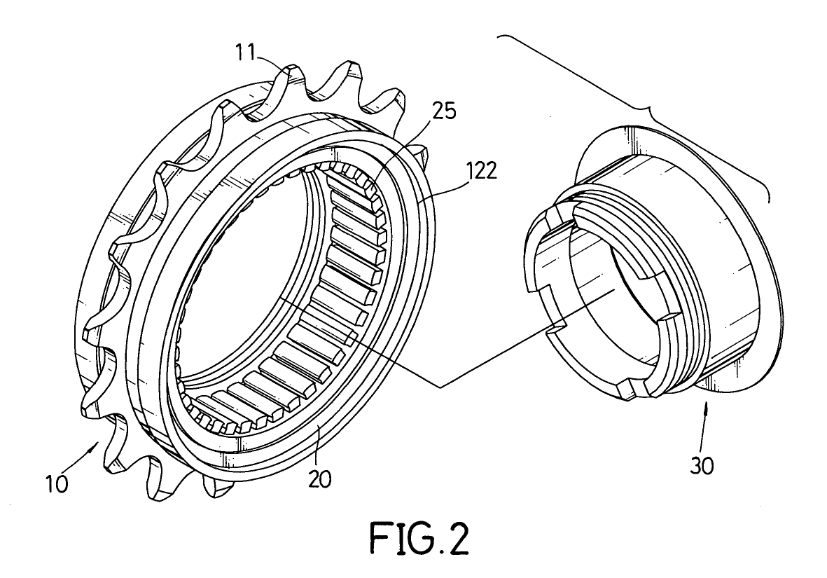

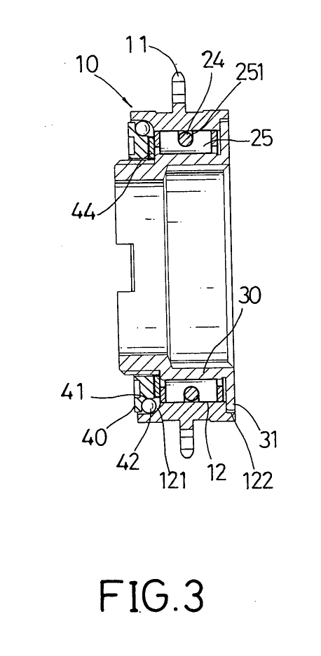

With reference to FIGS. 2, 3 and still taking FIG. 1 for reference, when the sprocket wheel of the present invention is to be assembled, the driving blocks (25) are received in the through holes (23) and then the elastic belt (24) is provided to be received in the aligned cutouts (251) so as to secure the driving blocks (25) in the driving ring (20). Then, the driving ring (20) is received in the space (12) with the annular pad (44) attached to one side of the driving ring (20). Thereafter, the sleeve (30) is inserted into the hollow driving ring (20) which is received in the space (12) to be threadingly connected to the side cap (40).

It is to be noted especially in FIG. 3 that after the mating of the ball receiving recess (41) and the first annular recess (121), the balls (42) are securely retained.

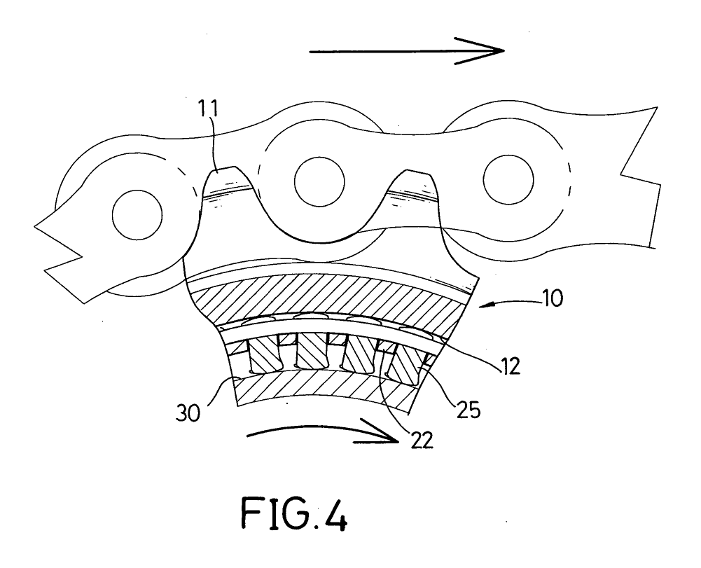

With reference to FIG. 4, when the chain (not numbered) is driven by the turning of the pedals (not shown nor numbered), due to the secure connection between the chain and the teeth (11), the sprocket wheel body (10) is driven by the chain. The driving blocks (25) are securely engaged with an inner periphery of the sprocket wheel body (10) and an outer periphery of the sleeve (30) such that the rotation of the sprocket wheel body (10) drives the sleeve (30) to rotate simultaneously. Because the inner threading (32) of the sleeve (30) is threadingly connected to the axle (not shown) of the rear wheel of the bicycle, the rear wheel of the bicycle is also driven to rotate.

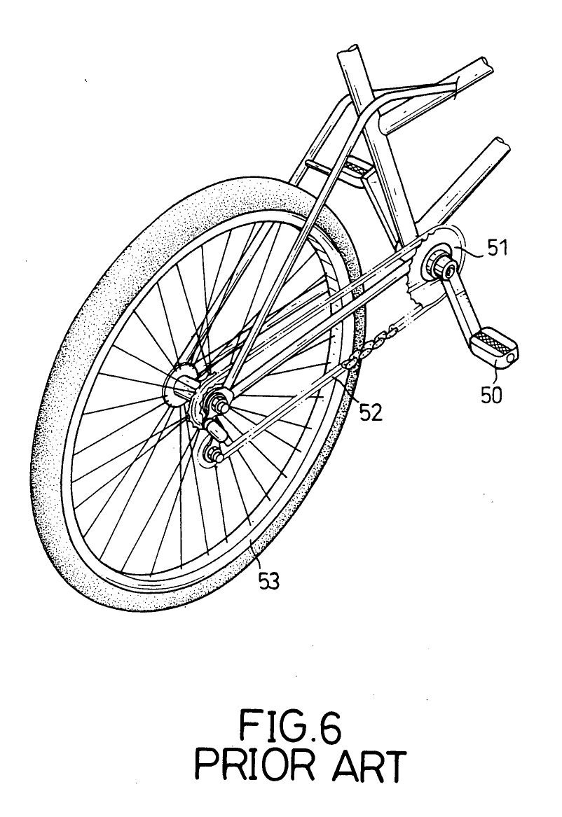

With reference to FIG. 6, if in a situation such as coating down a hill the chain remains still and the sleeve (30), due to the secure engagement with the rear wheel, will still be rotating. The rotation of the sleeve (30) tilts one end of the driving blocks (25), whereby the top faces (252) of the driving blocks (25) are no longer in contact with the inner periphery of the sprocket wheel body (10) and therefore, the sprocket wheel is substantially silent.

However, when the sprocket wheel body (10) is rotated again due to the driving of the chain and the rotation velocity of the sprocket wheel body (10) is larger than a rotation velocity of the sleeve (30), the tilted driving blocks (25) will return to their original position and then securely engage between the inner periphery of the sprocket wheel body (10) and the outer periphery of the sleeve (30) so as to drive the rear wheel to rotate.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. In a bicycle sprocket wheel having a sprocket wheel body provided with teeth formed on an outer periphery thereof to adapt to a bicycle chain so as to be driven to rotate by the bicycle chain, a driving ring received in the sprocket wheel body, a sleeve adapted to engage with a rear wheel of the bicycle so as to rotate simultaneously with the rear wheel and being inserted into the driving ring to engage with a side pad, wherein the improvements comprise:
the driving ring is so configured that the driving ring is selectively rotated with the sprocket wheel body in a noise-free manner.

2. The bicycle sprocket wheel as claimed in claim 1, wherein the driving ring has multiple partitions so as to define therein multiple through holes to receive therein multiple driving blocks, each driving block has a length L slightly larger than a length of the through hole, a width W slightly smaller than a width of the through hole, and an arcuate top face,
whereby the top face of each of the driving blocks is selectively engaged with an inner periphery of the sprocket wheel body and a bottom of each of the driving blocks is securely engaged with an outer periphery of the sleeve so that when the sprocket wheel remains still and the sleeve is rotated by the rear wheel, the driving blocks are tilted and thus the top faces of the driving blocks are free from engagement with the inner periphery of the sprocket wheel body.

3. The bicycle sprocket wheel as claimed in claim 2, wherein the side cap has a ball receiving recess defined to correspond to a first annular recess formed on one side of the sprocket wheel body so as to receive therein balls.

4. The bicycle sprocket wheel as claimed in claim 3, wherein an annular pad is sandwiched between the side cap and the sprocket wheel body.

5. The bicycle sprocket wheel as claimed in claim 2, wherein each driving block has a cutout defined in a mediate portion thereof and each of the cutouts correspond to and align with one another so as to receive therein an elastic belt to secure the driving blocks in the sprocket wheel body.

6. The bicycle sprocket wheel as claimed in claim 3, wherein each driving block has a cutout defined in a mediate portion thereof and each of the cutouts correspond to and align with one another so as to receive therein an elastic belt to secure the driving blocks in the sprocket wheel body.

7. The bicycle sprocket wheel as claimed in claim 4, wherein each driving block has a cutout defined in a mediate portion thereof and each of the cutouts correspond to and align with one another so as to receive therein an elastic belt to secure the driving blocks in the sprocket wheel body.
